(19) United States
(12) Patent Application Publication
(10) Pub. No.: US 2009/0146494 A1
(43) Pub. Date: Jun. 11, 2009

(54) Apparatus For Providing Electrical Power To Electrical Device And Method Of Use

(75) Inventors: Kenneth Mori, Los Angeles, CA (US); Yoko Iida, Tokyo (JP); Jon Roepke, Hermosa Beach, CA (US); Hanoz Gandhi, Marina del Rey, CA (US); Gid Herman, Monrovia, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 12/245,556

(22) Filed: Oct. 3, 2008

Related U.S. Application Data
(63) Continuation-in-part of application No. 12/034,836, filed on Feb. 21, 2008.
(60) Provisional application No. 60/977,312, filed on Oct. 3, 2007.
(60) Provisional application No. 60/977,248, filed on Oct. 3, 2007.

(51) Int. Cl. H02J 3/00

(52) U.S. Cl. 307/38

(57) ABSTRACT

In some embodiments, a surge protector includes: (a) an electrical connector configured to receive electrical power; (b) one or more receivers configured to receive input via wireless signals; (c) at least one first switch electrically coupled to the electrical connector; (d) one or more first electrical outlets; and (e) one or more second electrical outlets electrically coupled to the electrical connector. In these embodiments, each switch of the at least one first switch is electrically coupled to at least one of the one or more first electrical outlets and at least one of the one or more receivers. The at least one first switch is configured to turn on or turn off the electrical power to the one or more first electrical outlets based on the input received by the one or more receivers. Furthermore, the one or more second electrical outlets are coupled to the electrical connector such that when the electrical connector receives electrical power, the one or more second electrical outlets receive electrical power. Other embodiments are disclosed in this application.

### CROSS-REFERENCE TO RELATED APPLICATIONS

This application claims the benefit of U.S. Provisional Application No. 60/977,312, filed Oct. 3, 2007 and U.S. Provisional Application No. 60/977,248, filed Oct. 3, 2007.

This is also a continuation-in-part application of U.S. application Ser. No. 12/034,836, filed Feb. 21, 2008. U.S. Provisional Application Nos. 60/977,312 and 60/977,248 and U.S. application Ser. No. 12/034,836 are incorporated herein by reference.

### DESCRIPTION OF THE BACKGROUND

Many electrical devices such as televisions, computers, computer monitors, stereo equipment, VCRs (video cassette recorders), DVDs (digital video disk players), printers, scanners, HDTVs (high definition televisions), and the like, can continue to consume power even when switched off. Over an extended period of time, nominally off electrical devices can consume a significant amount of electrical power and substantially raise the electrical bill of the user. One study found that 23% of electrical power consumed by a television and over 50% of the electrical power consumed by a VCR is used when the electrical devices are nominally off.

In another situation, a person might forget to turn off an electrical device when he is finished using the electrical device. For example, a person may remember to turn the computer off after he finishes using it. However, he may forget to turn off the printer, coupled to the computer, and the printer continues to consume electrical power when the person has no intention of using the printer for an extended period of time.

Power strips have become increasingly common because of the increased number of electrical devices in the home and office that people want to plug into a single outlet. Therefore, instead of plugging the electrical devices directly into the electrical outlet on the wall, many people use power strips, or the like.

When electrical devices are plugged into a power strip, a user can stop the power consumption of even nominally off electrical devices by toggling off the electrical power to the power strip. However, power strips are usually located behind a desk, a television stand, or the like, and accessing the power strips can be hard and/or inconvenient.

Accordingly, a need or potential for benefit exists for an apparatus or system that allows a user to easily switch on and off the electrical power to electrical outlets of a power strip without having to physical access the power strip.

### BRIEF DESCRIPTION OF THE DRAWINGS

To facilitate further description of the embodiments, the following drawings are provided in which:

FIG. 1 illustrates an apparatus for providing power to an electrical device, according to a first embodiment;

FIG. 2 is a diagram illustrating a power strip of the apparatus of FIG. 1, according to the first embodiment;

FIG. 3 is a block diagram illustrating a control device of the apparatus of FIG. 1, according to the first embodiment,

FIG. 4 is a diagram illustrating a power strip, according to a second embodiment;

FIG. 5 is a diagram illustrating a power strip, according to a third embodiment;

FIG. 6 is a diagram illustrating an apparatus for providing power to an electrical device, according to a fourth embodiment;

FIG. 7 is a diagram illustrating an apparatus for providing power to an electrical device, according to a fifth embodiment;

FIG. 8 is a diagram illustrating a power strip, according to a sixth embodiment;

FIG. 9 illustrates a charging station, according to a seventh embodiment;

FIG. 10 is a diagram illustrating the charging station of FIG. 9, according to the seventh embodiment;

FIG. 11 is a flow chart illustrating a method of providing electrical power to an electrical device, according to an eighth embodiment;

FIG. 12 illustrates a system for providing electrical power to an electrical device, according to a ninth embodiment,

FIG. 13 is a block diagram illustrating a control device of FIG. 12, according to the ninth embodiment;

FIG. 14 is a block diagram illustrating a signal management device of FIG. 12, according to the ninth embodiment;

FIG. 15 illustrates a flow chart for an embodiment of a method of providing electrical, according to a tenth embodiment;

FIG. 16 illustrates a system for providing electrical power to an electrical device, according to an eleventh embodiment; and

FIG. 17 is a block diagram illustrating a repeater of FIG. 16, according to the eleventh embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, system, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “on,” as used herein, is defined as on, at, or otherwise adjacent to or next to or over.

The terms “couple,” “coupled,” “couples,” “coupling,” and the like should be broadly understood and refer to connecting two or more elements or signals, electrical, physical, mechanical, and/or other manner. Two or more electrical elements may be electrically coupled but not be mechanically coupled; two or more mechanical elements may be mechanically coupled but not be electrically coupled; two or more electrical elements may be mechanically coupled but not be electrically coupled. Coupling (whether only mechanical, only electrical, or both) may be for any length of time, e.g., permanent or semi-permanent or only for an instant.

“Electrical coupling” and the like should be broadly understood and include coupling involving any electrical signal or connection, whether a power signal or connection, a data signal or connection, and/or other types or combinations of electrical signals or connections. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

A surge protector includes: (a) an electrical connector configured to receive electrical power; (b) one or more receivers configured to receive input via wireless signals, (c) at least one first switch electrically coupled to the electrical connector; (d) one or more first electrical outlets, and (e) one or more second electrical outlets electrically coupled to the electrical connector. In these embodiments, each switch of the at least one first switch is electrically coupled to at least one of the one or more first electrical outlets and at least one of the one or more receivers. The at least one first switch is configured to turn on or turn off the electrical power to the one or more first electrical outlets based on the input received by the one or more receivers. Furthermore, the one or more second electrical outlets are coupled to the electrical connector such that when the electrical connector receives electrical power, the one or more second electrical outlets receive electrical power.

Another embodiment discloses an apparatus for providing electrical power to a first electrical device. The apparatus includes: (a) an electrical power device having: (1) a switch; (2) at least two first electrical connectors electrically coupled to the switch; (3) at least one second electrical connector; and (4) a receiver electrically coupled to the switch and configured to wirelessly receive information; and (b) a control device having: (1) a transmitter configured to wirelessly transmit the information to the receiver of the electrical power device; and (2) a user input mechanism electrically coupled to the transmitter and configured to receive the information from a user. In these embodiments, the switch is configured to toggle electrical power to the at least two first electrical connectors based on the information received by the receiver. The at least one second electrical connector receives electrical power when the electrical power device is receiving electrical power regardless of the information received by the receiver.

Still another embodiment discloses a system for providing electrical power to at least one first electrical device. The system includes: (a) a electrical power device having: (1) at least one first electrical connector configured to electrically couple to the at least one first electrical device; (2) a first receiver configured to receive a first wireless signal over a first medium; and (3) a switch electrically coupled to the first receiver and the at least one first electrical connector, the switch configured to control providing of electrical power to the at least one first electrical connector based on the first wireless signal; and (b) a signal management device having: (1) a second receiver configured to receive a second wireless signal over a second medium; and (2) a first transmitter electrically coupled to the second receiver and configured to transmit the first wireless signal over the first medium.

A further embodiment discloses a method of providing electrical power to a first electrical device and a second electrical device. The method including: (a) electrically coupling a first electrical outlet of a electrical power device to an electrical connector of the first electrical device, (b) electrically coupling a second electrical outlet of the electrical power device to an electrical connector of the second electrical device; (c) receiving first input from a user; (d) transmitting a first signal over a first wireless medium, the first signal comprises the first input; (e) receiving the first signal; (f) providing or stopping to provide electrical power to the first electrical connector of the first electrical device based on the first signal; and (g) providing electrical power to the second electrical connector of the second electrical device regardless of the first signal.

A still additional embodiment discloses an apparatus capable of providing electrical power. The apparatus includes: (a) a power strip with at least two electrical outlets; (b) a remote control configured to receive user input; (c) a base station configured to receive the user input via a first electromagnetic signal from the remote control and transmit the user input to the power strip via a second electromagnetic signal. In this embodiment, the power strip is configured to toggle electrical power to at least a first one of the at least two electrical outlets based on the user input. In some examples, the base station is configured to removably couple to the remote control such that the base station can provide electrical power to the remote control.

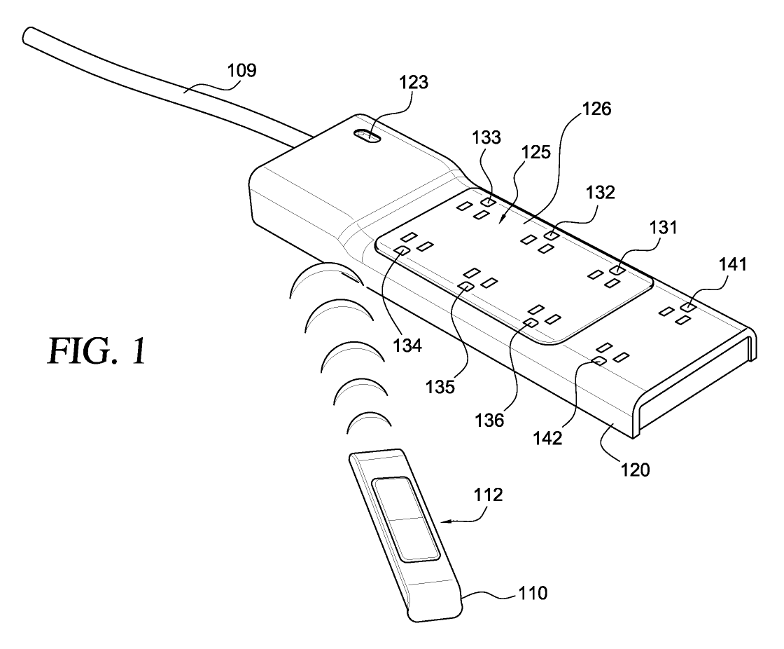

Turning to the drawings, FIG. 1 illustrates an apparatus 100 for providing power to an electrical device, according to a first embodiment. Apparatus 100 is merely exemplary and is not limited to the embodiments presented herein. Apparatus 100 can be employed in many different embodiments or examples not specifically depicted or described herein.

In some embodiments, a system or an apparatus 100 for an electrical device (not shown) can include: (a) a control device 110; and (b) an electrical power device 120. Control device 110 can be configured to control electrical power device 120.

In many examples, a user can input instructions into control device 110, and control device 110 communicates the instructions to electrical power device 120 via a wireless medium. Electrical power device 120 can carry out the instructions from the user and provide electrical power to, or stop providing electrical power to, one or more electrical devices coupled to electrical power device 120. Allowing a user to remotely turn on or turn off at least a portion of the electrical outlets of electrical power device 120, enables the user to cut electrical power to specific electrical devices when the electrical device is not in use. Accordingly, the power consumption by electrical devices not in use or nominally off can be stopped without having to turn off all the electrical devices coupled to electrical power device 120 and with having to physically access electrical power device 120.

In some embodiments, control device 110 can communicate the wireless signal to electrical power device 120 using a radio frequency signal. In various examples, using a radio frequency signal is preferred because radio frequency signal can pass through objects (e.g., desks and television stands). In other embodiments, control device 110 can communicate using infrared, Bluetooth, WiFi (Wireless Fidelity), or other wireless signals.

The embodiments described herein and illustrated in the figures exemplify an electrical power device 120 as a power strip. However, electrical power device 120 can be or include a power strip, power conditioners, a charging station, surge protectors, battery back-ups, duplex outlets, extension cords, and the like. In some embodiments, the power strip can include a surge protector. In the same or different embodiments, apparatus 100 can include more than one power strip configured to receive user instructions via control device 110.

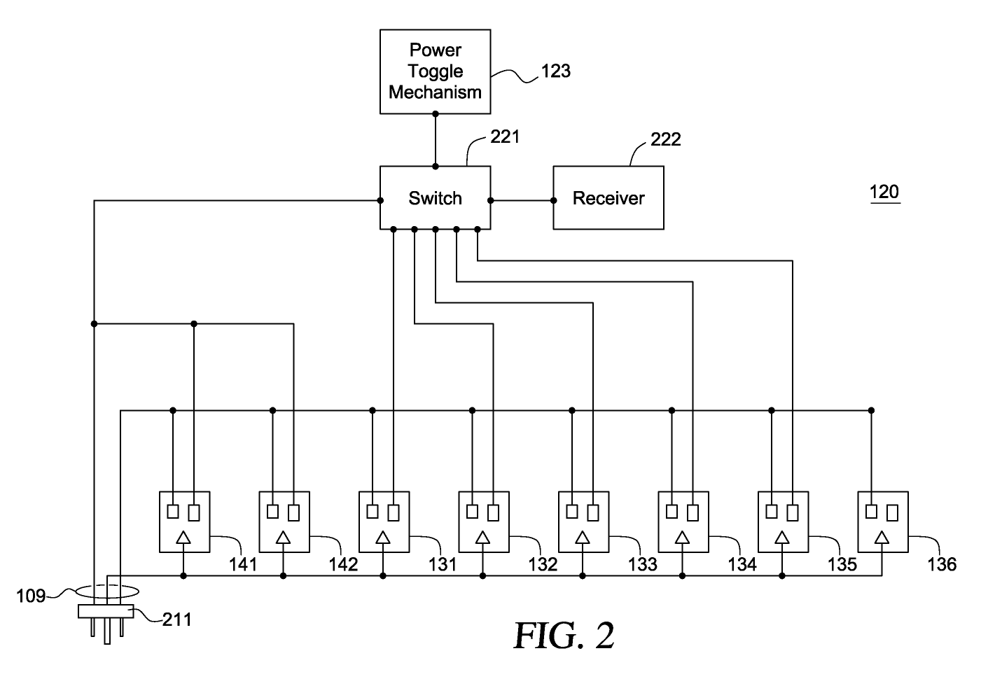

FIG. 2 is a diagram illustrating electrical power device 120, according to the first embodiment. Referring to FIGS. 1 and 2, electrical power device 120 can include: (a) one or more electrical connectors or electrical outlets 131, 132, 133, 134, 135, 136, 141, and 142; (b) a toggle mechanism or a switch 221 (FIG. 2) electrically coupled to electrical outlets 131, 132, 133, 134, 135, and 136; (c) receiver 222 (FIG. 2) electrically coupled to switch 221; (d) a switch or power toggle mechanism 123 electrically coupled to switch 221; (e) an electrical connector or plug 211 (FIG. 2) electrically coupled to switch 221 and electrical outlets 131, 132, 133, 134, 135, 136, 141, and 142, and receiver 222; and (f) a cable 109 coupling plug 211 to switch 221 and electrical outlets 131, 132, 133, 134, 135, 136, 141, and 142.

In the illustrated examples, each of electrical outlets 131, 132, 133, 134, 135, 136, 141, and 142 have three receptacles: hot, neutral, and ground. In some examples, one of the hot and neutral receptacles of each of electrical outlets 131, 132, 133, 134, 135, and 136 are electrically coupled to switch 221. The ground prong and the other one of the hot and neutral receptacles of each of electrical outlets 131, 132, 133, 134, 135, and 136 are electrically coupled to plug 211. In the illustrated embodiment, all three receptacles of electrical outlets 141 and 142 are electrically coupled to plug 211 without being routed through switch 221. Also, electrical outlets 141 and 142 are not controlled by power toggle mechanism 123 or receiver 222. That is, electrical outlets 141 and 142 are always on when plug 211 is coupled to an external electrical source (e.g., a wall electrical outlet).

Switch 221 is configured to toggle electrical power on and off to electrical outlets 131, 132, 133, 134, 135, and 136. In some examples, switch 221 can toggle the electrical power in each of electrical outlets 131, 132, 133, 134, 135, and 136 individually. For example, switch 221 could turn off electrical outlet 131 while leaving electrical outlets 132, 133, 134, 135, and 136 in their current power status (i.e., on or off).

In other examples, switch 221 can be configured to change the power status of groups of electrical outlets 131, 132, 133, 134, 135, and 136. For example, switch 221 could be configured such that electrical outlets 131, 132, and 133 are always tuned on and off together. Likewise, in these examples, switch 221 could be configured to always turn on or turn off electrical outlets 134, 135, and 136 as a group. In yet a further embodiment, switch 221 can be configured to toggle the electrical power to all of electrical outlets 131, 132, 133, 134, 135, and 136 as a group.

Receiver 222 can be configured to receive electromagnetic signals and communicate the information in the electromagnetic signals to switch 221. That is, receiver 222 can receive instructions from control device 110 regarding toggling electrical power to one or more of electrical outlets 131, 132, 133, 134, 135, and 136. In some examples, receiver 222 is configured to receive RF signals. In some examples, receiver 222 can be configured to receive infrared, Bluetooth, Wi-Fi or other wireless signals.

In some embodiments, electrical power device 120 can include a second receiver (not shown) to receive signals over a second medium, or receiver 222 could be configured to receive signals over a second medium. In the same or different embodiments, switch 221 and receiver 222 can be integrated into a single component, instead of being two separate components. For example, a single integrated circuit or controller could include receiver 222 and switch 221.

In some embodiments, electrical power device 120 can also include power toggle mechanism 123. In many examples, power toggle mechanism 123 is a button, a knob, a keypad, a touch screen, a mechanical switch, or a multitude of such devices that allows a user to manually turn on or off the power to electrical outlets 131, 132, 133, 134, 135, and 136. In other embodiments, power toggle mechanism 123 can be configured to allow a user to turn on or turn off all or a subset of electrical outlets 131, 132, 133, 134, 135, 136, 141, and 142.

In some embodiments, electrical power device 120 can also include a visual indication 125 (FIG. 1) of which electrical outlets can be controlled via control device 110. Including visual indication 125 on electrical power device 120 allow a user to easily identify the electrical outlet controlled by control device 110 and/or power toggle mechanism 123.

In the example illustrated in FIG. 1, visual indication 125 is a coloring of a portion 126 of the exterior surface of electrical power device 120 surrounding, electrical outlets 131, 132, 133, 134, 135, and 136. In other embodiments, the electrical outlets controllable by control device 110 can have a first orientation, and the electrical outlet not controllable by control device 110 can have a second orientation. In one example, the electrical outlet controllable by control device 110 can be parallel to a width of electrical power device 120, and the electrical outlets not controllable by control device 110 can be parallel to a length of electrical power device 120.

In the same or different example, the exterior surface of electrical power device 120 can include text or a sticker identifying the controllable electrical outlets. In still other embodiments, the exterior surface region around the controllable electrical outlets can be raised or depressed in relation to the exterior surface region around the non-controllable outlets.

In some embodiments, electrical outlets 131, 132, 133, 134, 135, 136, 141, and 142 can be standard AC (alternative current) outlets. In other examples, one or more of electrical outlets 131, 132, 133, 134, 135, 136, 141, and 142 can be DC (direct current) connectors or other types of connectors such as USB (universal serial bus) connectors, RJ11 (registered jack) connectors, or the like.

In some examples, electrical power device 120 can include additional electrical components used to provide electrical power to electrical outlets 131, 132, 133, 134, 135, 136, 141, and 142. In these examples, switch 221 can also stop providing electrical power to one or more of these electrical components when electrical power device 120 stops providing electrical power to electrical outlets 131, 132, 133, 134, 135, and 136. Stopping providing electrical power to these electrical components can help reduce the electrical power used by electrical power device 120.

In some examples, electrical power device 120 can include additional electrical components used to provide electrical power to electrical outlets 131, 132, 133, 134, and 141. In these examples, switch 221 can also stop providing electrical power to one or more of these electrical components when electrical power device 120 stops providing electrical power to electrical outlets 131, 132, 133, 134, and 141. Stopping providing electrical power to these electrical components can help reduce the electrical power used by electrical power device 120.

For example, if electrical power device 120 receives AC electrical power and converts the AC electrical power into DC electrical power, electrical power device 120 can include transformers, bridge rectifiers, and the like. When switch 221 stops providing electrical power to electrical outlets 131, 132, 133, and/or 134, electrical power device 120 can also stop providing electrical power to one or more of the transformer, bridge rectifiers, and the like.

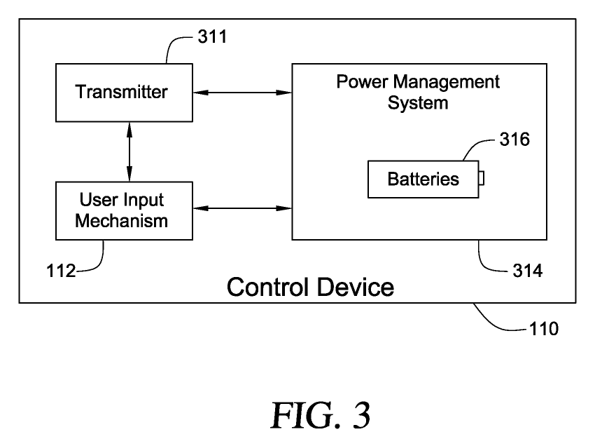

FIG. 3 is a block diagram illustrating, control device 110, according to the first embodiment. In some examples, control device 110 is a remote control. In the embodiment illustrated in FIG. 3, control device 110 can include: (a) a transmitter 311 configured to transmit a wireless signal, (b) a power management system 314 electrically coupled to transmitter 311; and (c) a user input mechanism 112 electrically coupled to transmitter 311 and power management system 314.

User input mechanism 112 can be configured to receive instructions from a user. In various examples, user input mechanism 112 can be one or more buttons or knobs, mechanical switches, or a keypad. In another example, user input mechanism 112 can be a touch screen. User input mechanism 112 can be configured to communicate the user instruction to transmitter 311.

Transmitter 311 is configured to transmit the user instructions using a wireless signal to electrical power device 120 (FIG. 1). In many examples, the wireless signal transmitted by transmitter 311 is an RF signal. In other examples, the wireless signals transmitted by transmitter 311 are infrared, Bluetooth, or WiFi signals.

In many embodiments, control device 110 can have a second transmitter (no shown) configured to transmit wireless signals using a second medium or frequency. In yet still other embodiments, transmitter 311 can transmit wireless signals using two or more mediums or frequencies.

Power management system 314 is configured to provide power for control device 110. In one example, power management system 314 can include one or more batteries 316. Batteries 316 can provide electrical power to control device 110. In various examples, batteries 316 can be disposable or rechargeable batteries.

In the same or different examples, control device 110 can be a standard universal remote or a remote for a television, cable box, audio system, or the like. That is, in some embodiments, control device 110 is not a device specially designed and manufactured to work with apparatus 100. Control device 110 can be a device capable of transmitting wireless signals over the predetermined medium and capable of being programmed to control electrical power device 120 for example.

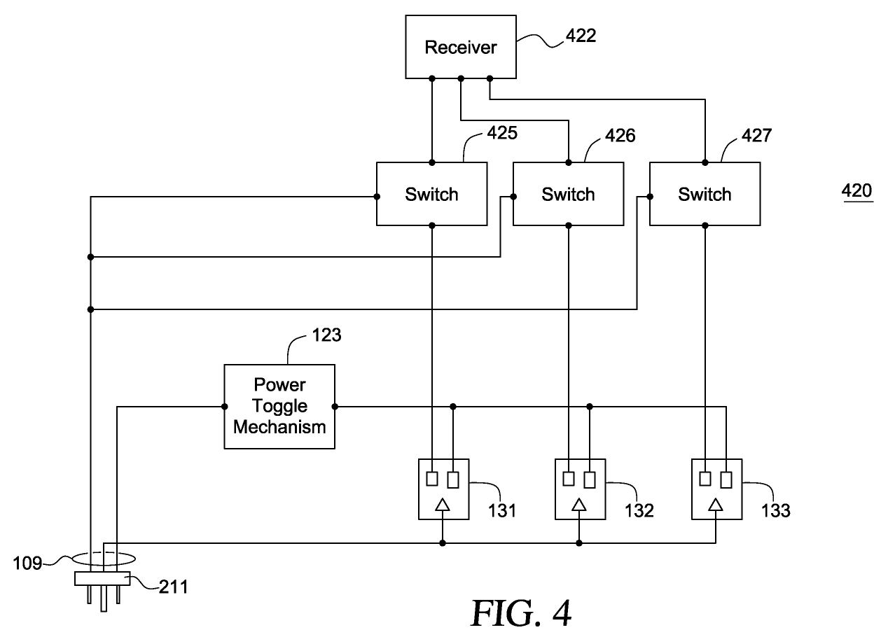

FIG. 4 is a diagram illustrating an electrical power device 420, according to a second embodiment. Electrical power device 420 can be used in apparatus 100 (FIG. 1) in place of or in addition to electrical power device 120 (FIGS. 1 and 2).

Referring, to FIG. 4, electrical power device 420 can include: (a) one or more electrical outlets 131, 132, and 133; (b) two or more switches 425, 426, and 427 electrically coupled to electrical outlets 131, 132, and 133, respectively; (c) a receiver 422 electrically coupled to switches 425, 426, 427; (d) power toggle mechanism 123 electrically coupled to electrical outlets 131, 132, and 133 (e) plug 211 electrically coupled to power toggle mechanism 123, switches 425, 426, 427, electrical outlets 131, 132, and 133, and receiver 422, and (f) cable 109 coupling plug 211 to power toggle mechanism 123, switches 425, 426, 427, and electrical outlets 131, 132, and 133.

In the embodiment illustrated in FIG. 4, receiver 422 receives user instructions via an electromagnetic signal and communicates the user instructions to switches 425, 426, and 427. In one example, receiver 422 communicates the user instructions for electrical outlet 131 to switch 425. Likewise, receiver 422 communicates the user instructions for electrical outlets 132 and 133 to switches 426 and 427, respectively. Receiver 422 can be similar to receiver 222 (FIG. 2) except receiver 422 is configured to couple to three switches 425, 426, and 427 instead of one switch like receiver 222 (FIG. 2). Switches 425, 426, and 427 can be identical or similar to switch 221 (FIG. 2) except that they only have one output terminal.

Power toggle mechanism 123 can be coupled between plug 211 and electrical outlets 131, 132, and 133. In this embodiment, power toggle mechanism 123 can turn on or turn off electrical power to electrical outlets 131, 132, and 133

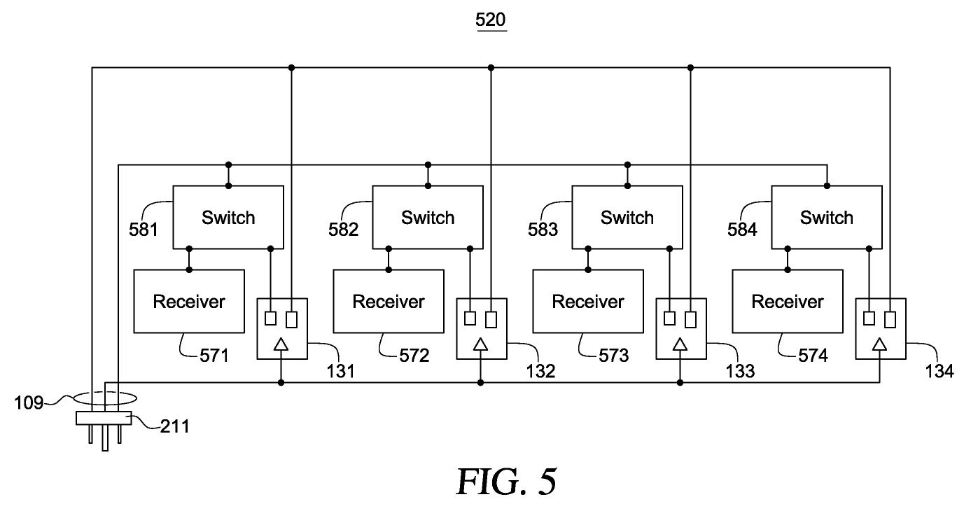

FIG. 5 is a diagram illustrating an electrical power device 520, according to a third embodiment. Electrical power device 520 can be used in apparatus 100 (FIG. 1) in place of or in addition to electrical power device 120 (FIGS. 1 and 2) and/or electrical power device 420 (FIG. 4).

Referring to FIG. 5, electrical power device 520 can include: (a) one or more electrical outlets 131, 132, 133, and 134; (b) one or more switches 581, 582, 583, and 584; (c) one or more receivers 571, 572, 573, and 574; (c) electrical plug 211 electrically coupled to electrical outlets 131, 132, 133, 134, switches 581, 582, 583, and 584, and receivers 571, 572, 573, and 574; and (d) cable 109 coupling electrical plug 211 to electrical outlets 131, 132, 133, and 134 and switches 581, 582, 583, and 584.

In the embodiment illustrated in FIG. 5, each of electrical outlets 131, 132, 133, and 134 are coupled to an individual switch, and the switch is coupled to a separate receiver. That is, electrical outlets 131, 132, 133, and 134, are electrically coupled to switches 581, 582, 583, and 584, respectively, and switches 581, 582, 583, and 584 are electrically coupled to receivers 571, 572, 573, and 574, respectively.

In this embodiment, each of receivers 571, 572, 573, and 574 is configured to receive information regarding turning on or turning off electrical outlets 131, 132, 133, and 134, respectively. That is, receivers 571, 572, 573, and 574 are configured to receive instructions via an electromagnetic signal from control device 110 (FIG. 1) and communicate the instructions to switches 581, 582, 583, and 584, respectively. Switches 581, 582, 583, and 584 are configured to toggle the electrical power to electrical outlets 131, 132, 133, and 134, respectively, based on the user instructions.

Receivers 571, 572, 573, and 574 can be identical or similar to receiver 222 (FIG. 2). Switches 581, 582, 583, and 584 can be identical or similar to switch 221 (FIG. 2) and/or switches 425, 426, and 427 (FIG. 4). However, receivers 571, 572, 573, and 574 can respond to different frequencies or signals sent by control device 110, for example.

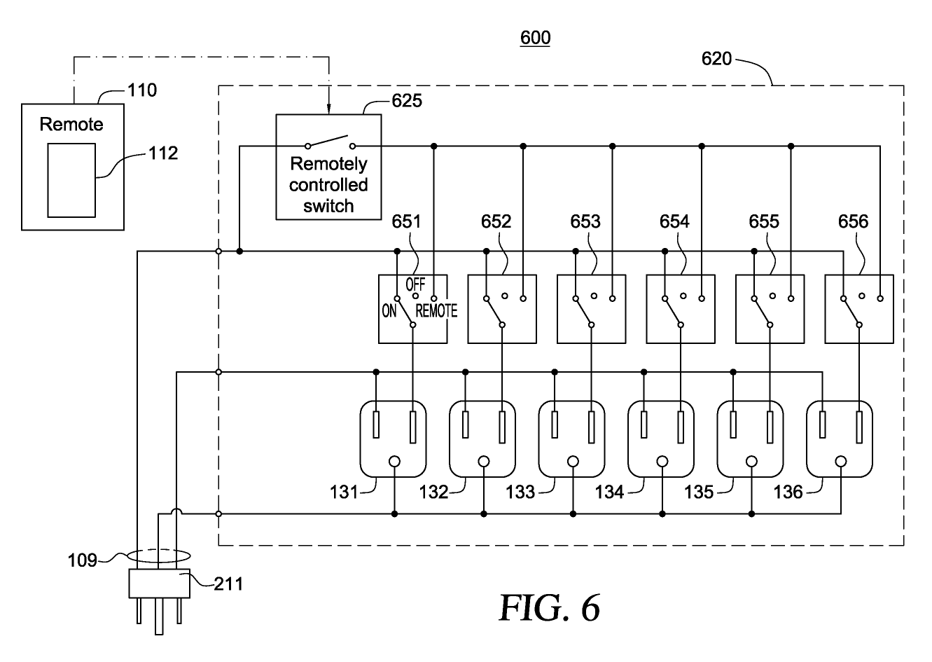

Turning to a further embodiment, FIG. 6 is a diagram illustrating an apparatus 600 for providing power to an electrical device, according to a fourth embodiment. In this embodiment, apparatus 600 can include: (a) a control device 110; and (b) an electrical power device 620.

Electrical power device 620 can include: (a) electrical outlets 131, 132, 133, 134, 135, and 136; (b) a switch 625; (c) one or more switches 651, 652, 653, 654, 655, and 656; (d) electrical plug 211 electrically coupled to switches 625, 651, 652, 653, 654, 655, 656, and 656, electrical outlets 131, 132, 133, 134, 135, and 136, and switch 625; and (d) cable 109 coupling plug 211 to switches 625, 651, 652, 653, 654, 655, 656, and 656 and electrical outlets 131, 132, 133, 134, 135.

Switches 651, 652, 653, 654, 655, and 656 are electrically coupled to electrical outlets 131, 132, 133, 134, 135, and 136, respectively. In this embodiment, a user can chose which of electrical outlets 131, 132, 133, 134, 135, and 136 are controllable by control device 110 using switches 651, 652, 653, 654, 655, and 656.

Switches 651, 652, 653, 654, 655, and 656 allow a user to choose one of three states (on, off, or remote controlled) for each of electrical outlets 131, 132, 133, 134, 135, and 136. For example, using switch 651, a user can choose if electrical outlet 131 is on, off, or remote controlled. If a user chooses to set switch 651 in the remote controlled position, a user can toggle the electrical power to electrical outlet 131 using control device 110. If a user sets electrical outlet 131 in the on position using switch 651, electrical power is provided to electrical outlet 131 until the user changes the setting using switch 651. If the user sets electrical outlet 131 in the off position using switch 651, electrical power is not provided to electrical outlet is off until the user changes the setting using switch 651.

In other embodiments, switches 651, 652, 653, 654, 655, and 656 allow a user to choose one of two states (off or remote control) for each of electrical outlets 131, 132, 133, 134, 135, and 136. In still a further embodiments, switches 651, 652, 653, 654, 655, and 656 allow a user to choose one of two states (on or remote control) for each of electrical outlets 131, 132, 133, 134, 135, and 136.

Switch 625 is configured receive user instructions via electromagnetic signals from control device 110. Based on the user instructions, switch 625 is configured to toggle electrical power to the electrical outlets that the user selected to be remote controlled using switches 651, 652, 653, 654, 655, and 656. In some embodiments, switch 625 can be identical to or similar to the combination of switch 221 (FIG. 2) and receiver 222 (FIG. 2).

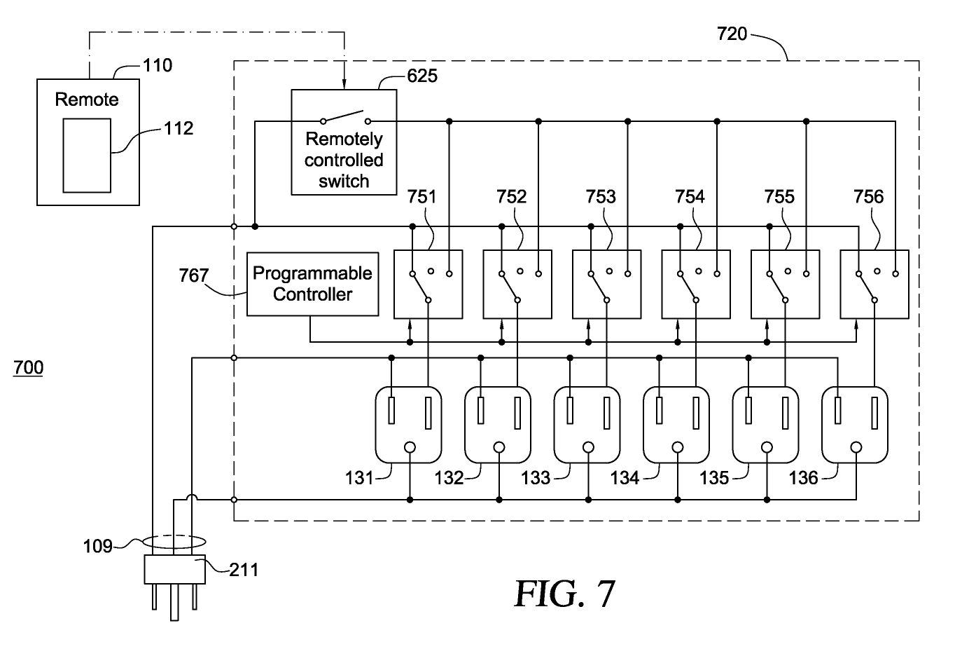

Turning to a yet another embodiment, FIG. 7 is a diagram illustrating an apparatus 700 for providing power to an electrical device, according to a fifth embodiment. In this embodiment, apparatus 700 can include: (a) control device 110; and (b) an electrical power device 720.

Electrical power device 720 can include: (a) electrical outlets 131, 132, 133, 134, 135, and 136; (b) switch 625; (c) one or more switches 751, 752, 753, 754, 755, and 756; (d) a controller 767; (e) electrical plug 211 electrically coupled to switches 751, 752, 753, 754, 755, 756, and 756, electrical outlets 131, 132, 133, 134, 135, and 136, and controller 767; and (f) cable 109 coupling plug 211 to switches 751, 752, 753, 754, 755, 756, and 756 and electrical outlets 131, 132, 133, 134, 135.

Controller 767 can be configured to control switches 751, 752, 753, 754, 755, and 756. Similar to switches 651, 652, 653, 654, 655, and 656 in FIG. 6, switches 751, 752, 753, 754, 755, and 756 in FIG. 7 can toggle between the three power states: on, off, and remote controlled. In some embodiments, controller 767 can include a keyboard or other user input mechanism to receive instructions from a user and/or memory to store the user instructions. In the same or different embodiments, controller 767 can be programmable using a computing device, such a computer, personal digital assistance, or the like.

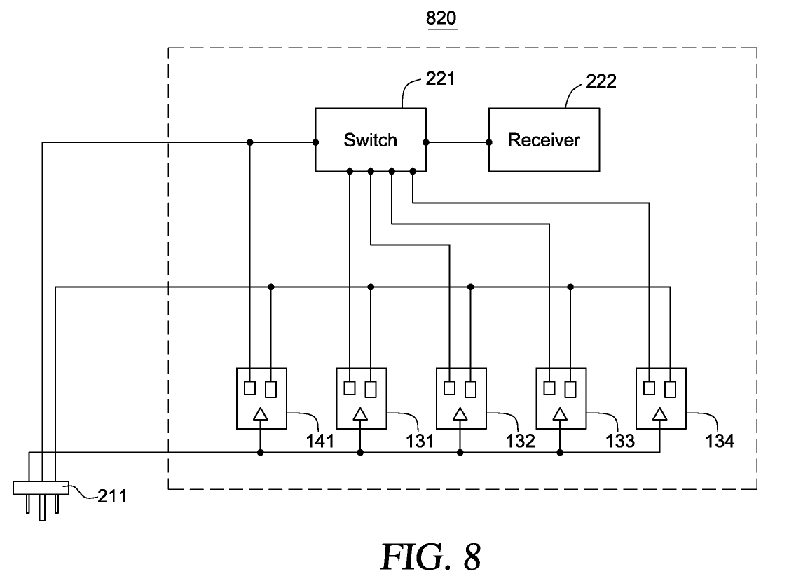

FIG. 8 is a diagram illustrating an electrical power device 820, according to the sixth embodiment. In embodiment illustrated in FIG. 8, an electrical device or an electrical power device 820 can include: (a) one or more electrical connectors or outlets 131, 132, 133, 134, and 141; (b) receiver 222 configured to receive a wireless signal over a wireless medium, and (c) switch 221 electrically coupled to receiver 222 and electrical outlets 131, 132, 133, and 134; (d) a electrical connector or electrical plug 211 electrically coupled to switch 221, electrical outlets 131, 132, 133, 134, and 141, and receiver 222. Electrical power device 820 can be configured to toggle the electrical power to electrical outlets 131, 132, 133, and 134 based on user input received by receiver 222. Electrical outlet 141 is configured to receive electrical power when electrical plug 211 receives electrical power from an external power source (not shown), and is not toggled based on user input received by receiver 222.

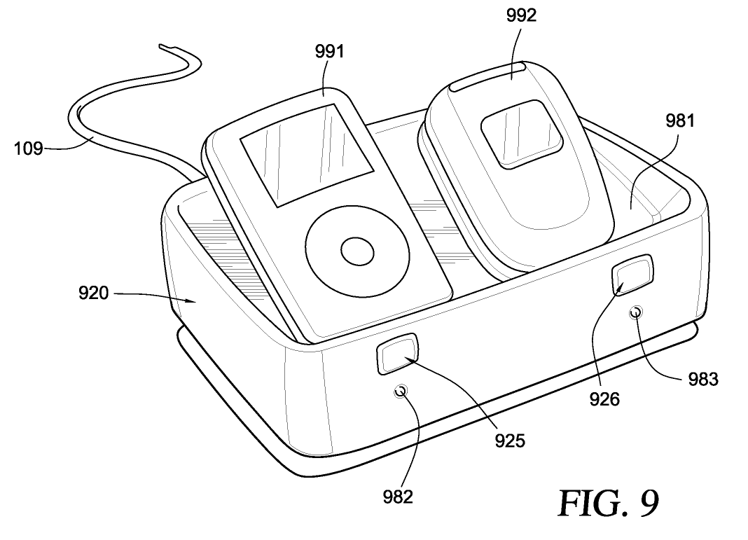

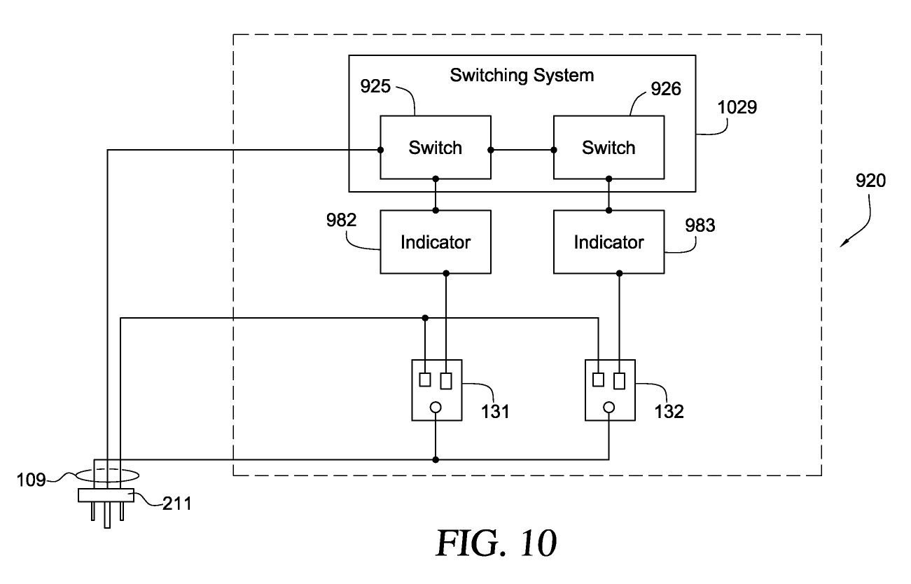

FIG. 9 illustrates a charging station 920, according to a seventh embodiment. FIG. 10 is a diagram illustrating charging station 920, according to the seventh embodiment. Charging station 920 can help limit power consumption by nominally off electrical devices, transformer, bridge rectifiers, and the like by stopping the providing of electrical power to these devices when charging station 920 is not charging any electrical devices or when the electrical devices are fully charged.

In this embodiment, charging station 920 includes: (a) two or more connectors or outlets 131 and 132; (b) a switching system 1029 having switches 925 and 926; (c) plug 211 electrically coupled to switching system 1029 and electrical outlets 131 and 132; and (d) cable 109 coupling plug 211 to switching system 1029 and electrical outlets 131 and 132.

In some examples, outlets 131 and 132 can be part of a power strip, surge protector, or the like. Electrical outlets 131 and 132 can be electrically coupled to switches 925 and 926, respectively. In one example, electrical device 991 and electrical device 992 can be coupled to electrical outlets 131 and 132, respectively. In some examples, electrical devices 991 and 992 can be electrical devices or accessories such as mobile phones, personal digital assistants (PDAs), digital music (MP3) players, or the like.

Switches 925 and 926 allow a user to independently toggle the electrical power to each of electrical outlets 131 and 132, respectively. In some embodiments, switches 925 and 926 are controllable by a control device 110 (FIG. 1). In other embodiments, switching system 1029 can include a mechanism to automatically toggle the electrical power to electrical outlets 131 and 132. For example, switching system 1029 could turn on electrical outlet 131 and/or 132 when one or more electrical devices are placed in charging station 920.

In one example, switching system 1029 could use a mechanical, optical, or weight system to automatically switch the electrical power on or off to each of electrical outlets 131 and 132. For example, tray 981 could include a device that detects the weight of electrical devices 991 or 992 and turn on the electrical power to at least one of electrical outlet 131 and 132 when the weight of the item is detected in tray 981. In another example, switching system 1029 could use an optical sensor to detect the placement of either of electrical devices 991 and 992 in tray 981. Switching system 1029 can also wirelessly receive user input.

In some examples, charging station can include one or more visual indicators 982 and 983. Visual indicators 982 and 983 can show that electrical power is being supplied to electrical outlets 131 and 132, respectively. For example, visual indicators 982 and 983 could be lights or a digital display.

Electrical outlets 131 and 132 are shown in FIG. 10 as AC electrical outlets. As in the other embodiments, electrical outlets 131 and 132 in charging station 920 can be DC (direct current) connectors or other types of connectors such as USB (universal serial bus) connectors, RJ11 (registered jack) connectors, or the like.

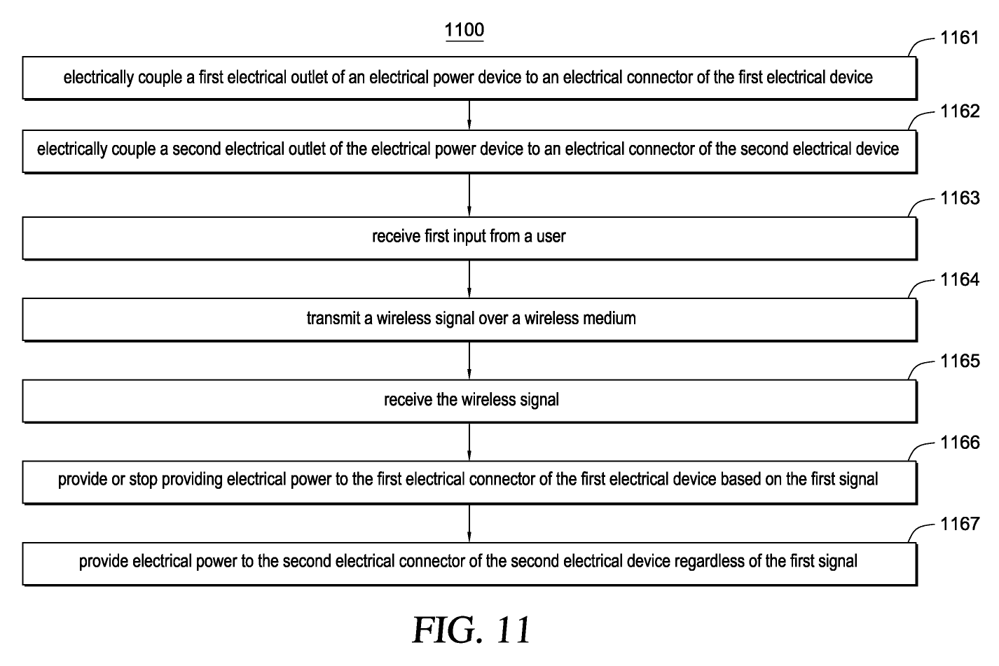

FIG. 11 is a flow chart illustrating a method 1100 of providing electrical power to electrical device, according to an eighth embodiment. Method 1100 is merely illustrative of a technique for implementing the various aspects of one embodiment described herein, and method 1100 is not limited to this particular embodiment, as numerous other embodiments are possible.

Referring to FIG. 11, in many embodiments, the first activity in method 1100 of FIG. 11 is an activity 1161 of electrically coupling a first electrical outlet of an electrical power device to an electrical connector of the first electrical device. For example, the electrical power device of activity 1161 can be identical or similar to electrical power device 120, 420, 520, 620, 720, 820, or 920 of FIGS. 1, 4, 5, 6, 7, 8, and 9, respectively. The electrical outlets can be identical or similar to electrical outlets 131, 132, 133, 134, 135, or 136 of FIGS. 1, 2, and 4-9.

The next activity in method 1100 of FIG. 11 is an activity 1162 of electrically coupling a second electrical outlet of the electrical power device to an electrical connector of the second electrical device. For example, the electrical outlets can be identical or similar to electrical outlets 141 or 142 of FIGS. 1, 2, and 8.

The next activity in method 1100 of FIG. 11 is an activity 1163 of receiving a first input from a user. In some examples, the first input can be instructions to turn on or turn off one or more of electrical outlets 131, 132, 133, 134, 135, or 136 (FIGS. 1, 2, 4-8, and 10). In some embodiments, activity 1163 can include receiving the first input from a user using a control device. For example, the control device can be identical or similar to control device 110 of FIGS. 1, 3, 6, and 7. In some examples, the user can enter the first user input into control device 110 using user input mechanism 112 of FIGS. 1, 3, and 6-7.

A subsequent activity in method 1100 of FIG. 11 is an activity 1164 of transmitting a wireless signal over a wireless medium. The signal transmitted over the wireless medium can contain the user input from activity 1163. In various embodiments, activity 1164 can include transmitting the wireless signal over the wireless medium using the control device. For example, transmitter 311 (FIG. 3) can be used transmit the wireless signal using a wireless medium. In one example, the wireless signal is transmitted using an RF signal. In other embodiments, the first wireless signal is transmitter using an infrared, Bluetooth, Wi-Fi, or other wireless signal.

The next activity in method 1100 of FIG. 11 is an activity 1165 of receiving the wireless signal. In some examples, the wireless signal can be received by an electrical power device. The electrical power device can be identical or similar to electrical power device 120, 420, 520, 620, 720, 820, or 920 of FIGS. 1 and 4-9. For example, receiver 222 (FIG. 2) of electrical power device 120 (FIGS. 1 and 2) can receive the wireless signal from transmitter 311 (FIG. 3) of control device 110 (FIG. 1).

A subsequent activity in method 1100 of FIG. 11 is an activity 1166 of providing or stopping the providing of electrical power to the first electrical device based on the wireless signal. In one example, the wireless signal is translated to an intermediary signal (e.g., electrical signals, such as an analog or digital signal) and transmitted from receiver 222 (FIG. 2) to switch 221 (FIG. 2). Switch 221 (FIG. 2) uses the intermediary signal, which contains the user instruction from activity 1163, to turn on or turn off at least one of electrical outlets 131, 132, 133, 134, 135, and 136 (FIGS. 1, 2, 4-8, and 10). That is, switch 221 (FIG. 2) can start or stop the providing of electrical power to the electrical device coupled to one of electrical outlets 131, 132, 133, 134, 135, and 136 (FIGS. 1, 2, 4-8, and 10).

The next activity in method 1100 of FIG. 11 is an activity 1167 of providing electrical power to the second electrical connector of the second electrical device regardless of the first signal. In some examples, electrical power is provided to the second electrical connector of the second electrical device through electrical outlets 141 and 142 (FIGS. 1, 2, and 8).

Activity 1163 through activity 1166 can be repeated to change the power setting of any or all of the first electrical outlets based on input from a user

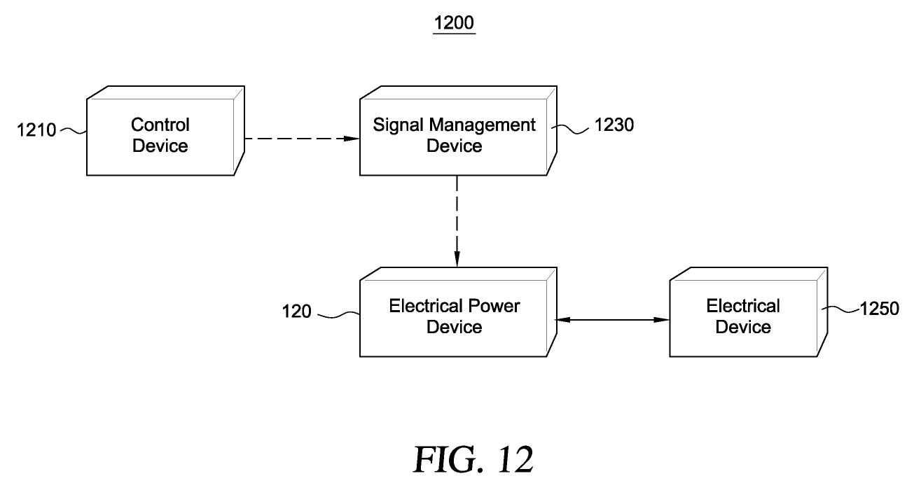

Turning to another embodiment, FIG. 12 illustrates a system 1200 for providing electrical power to an electrical device 1250, according to a ninth embodiment. System 1200 is merely exemplary and is not limited to the embodiments presented herein. System 1200 can be employed in many different embodiments or examples not specifically depicted or described herein.

In some embodiments, an apparatus or system 1200 for providing electrical power to electrical device 1250 can include: (a) a remote control or a control device 1210; (b) a base station or a signal management device 1230; and (c) an electrical power device 120.

In some embodiments, electrical power device 120 is configured to provide electrical power or stop providing electrical power to electrical device 1250 based on user input or instructions received from signal management device 1230 and/or control device 1210 via signal management device 1230. That is, in various examples, control device 1210 can receive instructions from a user and wirelessly transmit those instructions using a first wireless medium (i.e. an electromagnetic signal) to signal management device 1230. Signal management device 1230 can wirelessly transmit the instructions to electrical power device 120 using a second wireless medium. Electrical power device 120 can use those instructions to toggle the power (i.e., turn on or turn off) the electrical outlet coupled to electrical device 1250.

Allowing a user to remotely turn on or turn off electrical outlets of electrical power device 120, enables the user to cut electrical power to specific electrical devices when the electrical device is not in use. Accordingly, the power consumption by electrical devices not in use or nominally off can be stopped without having to turn off all the electrical devices coupled to electrical power device 120 and without having to physically access electrical power device 120.

In some examples, the first wireless medium is an infrared signal. In the same or different embodiments, the second wireless medium is an RF (radio frequency) signal. In other embodiment, either or both of the wireless mediums can be infrared signals or RF signals.

In some examples, using an infrared signal for the first wireless medium and a radio frequency signal as the second wireless medium is preferred because radio frequency signal can pass through objects (e.g., desks and television stands). Furthermore, using an infrared signal as the first wireless medium would make system 1200 compatible with many existing programmable universal, television, audio system, video cassette recorder (VCR), and digital video disk (DVD) remotes. In some embodiments, control device 1210 can communicate using an infrared, Bluetooth, Wi-Fi, or other wireless signal.

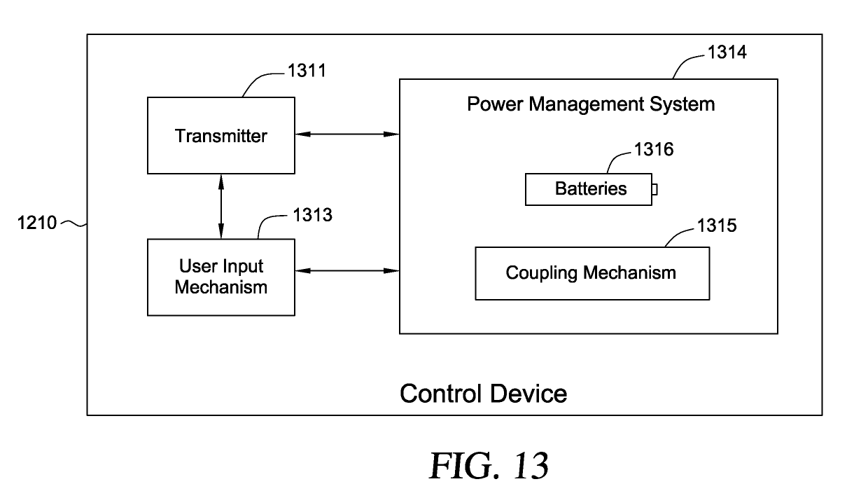

FIG. 13 is a block diagram illustrating control device 1210, according to the ninth embodiment. In some examples, control device 1210 is a remote control. In embodiment illustrated in FIG. 13, control device 1210 can include: (a) a transmitter 1311 configured to transmit a wireless signal; (b) a power management system 1314 electrically coupled to transmitter 1311; and (c) a user input mechanism 1313 electrically coupled to transmitter 1311 and power management system 1314.

User input mechanism 1313 can be configured to receive instructions from a user. In one example, user input mechanism 1313 can be one or more buttons or knobs, a keypad, or mechanical switches. In another example, user input mechanism 1313 can be a touch screen. User input mechanism 1313 can be configured to communicate the user instruction to transmitter 1311.

Transmitter 1311 is configured to transmit the user instruction using a wireless signal to signal management device 1230 (FIG. 12). In many examples, the wireless signal transmitted by transmitter 1311 is an infrared signal. In other examples, the wireless signal transmitted by transmitter 1311 is an RF signal.

Power management system 1314 is configured to provide power for control device 1210 (FIG. 12). In some embodiments, signal management device 1230 (FIG. 12) acts as a charging station for control device 1210.

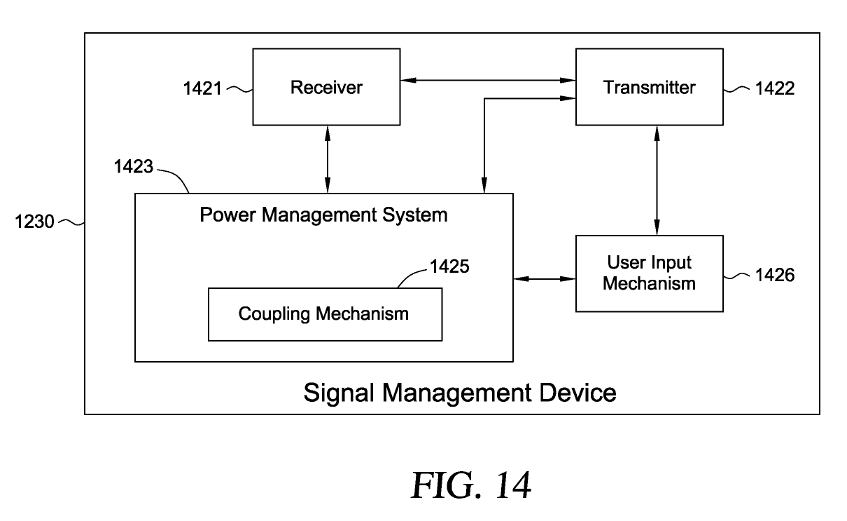

In one example, power management system 1314 can include: (a) one or more batteries 1316; and (b) a coupling mechanism 1315. Coupling mechanism 1315 can be configured to couple to a coupling mechanism 1425 (FIG. 14) of signal management device 1230 (FIG. 12). Coupling mechanisms 1315 and 1425 can be a complementary standard (or non-standard) connector that allows electrical power to be transferred from power management system 1314 to control device 1210 (FIG. 12). Similarly, in some embodiments, control device 110 (e.g., FIG. 1) can include coupling mechanism 1315.

When coupling mechanism 1315 is coupled to coupling mechanism 1425 (FIG. 14), signal management device 1230 (FIG. 12) can provide electrical power to power management system 1314 to charge batteries 1316 or power control device 1210. Batteries 1316 can provide electrical power to control device 1210 when control device 1210 is not coupled to signal management device 1230 (FIG. 12). In the same or different embodiments, batteries 1316 can be disposable batteries.

In other embodiments, power management system 1314 can be devoid of coupling mechanism 1315. In some examples, control device 1210 can be a standard universal remote or a remote for a television, cable box, audio system or the like. That is, control device 1210 does not have be a device specially designed and manufactured to work with system 1200. Control device 1210 can be a device capable of transmitting wireless signals over the predetermined medium and capable of being programmed to control electrical power device 120. In various examples, system 1200 can be configured such that using a control device 1210 to turn on or off an electrical device also turns on or off, respectively, the electrical outlet in electrical power device 120 that the electrical device is coupled to. For example, when a user turns on a television using the remote control for the television, system 1200 could also receive this wireless signal and turn on the electrical outlet in electrical power device 120 coupled to the television. In another embodiment, a different button on the remote control for the television could be programmed to toggle the power for the electrical outlet coupled to the television.

FIG. 14 is a block diagram illustrating signal management device 1230, according to the ninth embodiment. Signal management device 1230 can be configured to receive user input from control device 1210 (FIG. 13) via a wireless medium and transmit the user input to electrical power device 120 (FIG. 8) via a wireless medium.

In some examples, signal management device 1230 can include: (a) a receiver 1421; (b) a transmitter 1422 electrically coupled to receiver 1421; (c) a power management system 1423; and (d) a user input mechanism 1426.

Receiver 1421 can be configured to receive a wireless signal over the same medium and frequency as transmitter 1311 (FIG. 13) transmits. For example, transmitter 1311 (FIG. 13) can be configured to transmit an infrared signal, and receiver 1421 can be configured to receive and decode the infrared signal from transmitter 1311 (FIG. 13).

After receiving the wireless signal from transmitter 1311 (FIG. 13), receiver 1421 transmits the signal to transmitter 1422. In various embodiments, transmitter 1422 is configured to transmit the signal received from control device 1210 (FIG. 13) over a different medium and/or frequency. For example, if transmitter 1311 (FIG. 13) transmits an infrared signal, transmitter 1422 can be configured to transmit the signal as a radio frequency signal.

In some embodiments, user input mechanism 1426 can receive user instructions from the user. In these embodiments, user input mechanism 1426 communicates the user instructions to transmitter 1422, which transmits the instructions via a wireless signal over the second medium. In many examples, user input mechanism 1426 can be similar to or identical to user input mechanism 1313 (FIG. 13).

In various embodiments, power management system 1423 can provide electrical power for signal management device 1230. Power management system 1423 includes a coupling mechanism 1425. Coupling mechanism 1425 can be configured to couple to coupling mechanism 1315 (FIG. 13). Power management system 1423 can configured to provide electrical power to control device 1210 (FIG. 13) when coupling mechanism 1425 is coupled to coupling mechanism 1315 (FIG. 13). In some embodiments, power management system 1423 can further include one or more batteries.

In some embodiments, signal management device 1230 can also have other functions or be integrated with other electrical devices. For example, signal management device 1230 could include or be integrated with an electrical device for cable or satellite television (e.g., a cable box). In other examples, signal management device could be integrated with audio equipments or a DVD player.

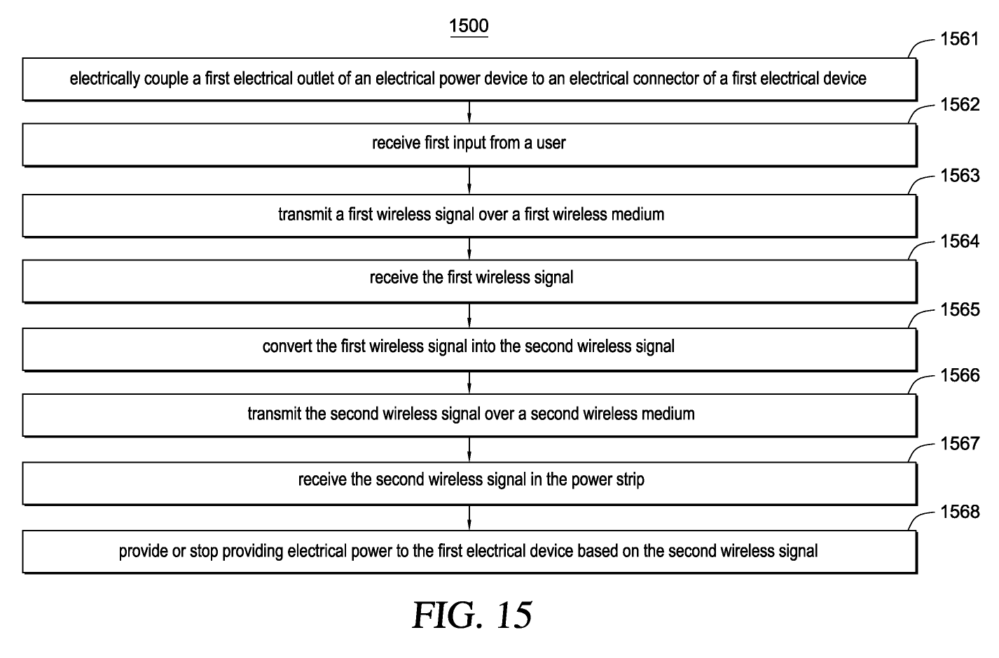

FIG. 15 is a flow chart illustrating a method 1500 of providing electrical power to electrical device 1250 (FIG. 12), according to a tenth embodiment. Method 1500 is merely illustrative of a technique for implementing the various aspects of one embodiment described herein, and system 1200 (FIG. 12), and method 1500 is not limited to this particular embodiment, as numerous other embodiments are possible.

In many embodiments, the first activity in method 1500 is an activity 1561 of electrically coupling an electrical outlet of an electrical power device to an electrical connector of a first electrical device. For example, the electrical power device of activity 1161 can be identical or similar to electrical power device 120, 420, 520, 620 720, 820, or 920 of FIGS. 1, 4, 5, 6, 7, 8 and 9, respectively. The electrical outlets can be identical or similar to electrical outlets 131, 132, 133, 134, 135, or 136 of FIGS. 1, 2, 4-8 and 10.

Referencing again FIG. 15, the next process in method 1500 is an activity 1562 of receiving first input from a user. In some examples, the first input can be instructions to turn on or turn off one or more of electrical outlets 131, 132, 133, 134, 135, or 136 of FIGS. 1, 2, 4-8 and 10. In some embodiments, activity 1562 can include receiving the first input from a user using a control device. In the example illustrated in FIGS. 12-14, the user can enter the first input into control device 1210 using user input mechanism 1313.

A subsequent activity in method 1500 is an activity 1563 of transmitting a first wireless signal over a first wireless medium. The signal transmitted over the first wireless medium can contain the first input from activity 1562. In various embodiments, activity 1563 can include transmitting the first wireless signal over the first wireless medium using a control device. In the example illustrated in FIGS. 12-14, transmitter 1311 of control device 1210 can transmit the first wireless signal using a first wireless medium. In one example, the first wireless signal is transmitter using an infrared signal. In other embodiments, the first wireless signal is transmitter using a RF, Bluetooth, Wi-Fi or other wireless signals.

The next activity in method 1500 is an activity 1564 of receiving the first wireless signal. In many embodiments, activity 1564 can include receiving the first wireless signal in a signal management device. In the example illustrated in FIGS. 12-14, receiver 1421 of signal management device 1230 receives the first wireless signal transmitted using transmitter 1311.

The next activity in method 1500 is an activity 1565 of converting the first wireless signal into the second wireless signal. Like the first wireless signal, the second wireless signal can contain the first input from activity 1562. In some examples, receiver 1421 (FIG. 14) can covert the first wireless signal into an intermediary signal (i.e., an electrical signal inside signal management device), which is communicated to transmitter 1422 (FIG. 14). Transmitter 1422 (FIG. 14) can covert the intermediary signal into the second wireless signal. In other embodiments, either receiver 1421 (FIG. 14) or transmitter 1422 (FIG. 14) can directly covert the first wireless signal into the second wireless signal.

A subsequent activity in method 1500 is an activity 1566 of transmitting or relaying the second wireless signal over a second wireless medium. In numerous embodiments, activity 1566 can include transmitting the second wireless signal over the second wireless medium using the signal management device. In the example illustrated in FIGS. 12-14, transmitter 1422 of signal management device 1230 can transmit the second wireless signal over the second wireless medium. In one example, the second wireless signal is transmitted using an RF signal. In other embodiments, the second wireless signal is transmitter using an infrared, Bluetooth, Wi-Fi or other wireless signals.

The next activity in method 1500 is an activity 1567 of receiving the second wireless signal in the electrical power device. In the example illustrated in FIGS. 12-14, a receiver of electrical power device 120 can receive the second wireless signal from transmitter 1422 of signal management device 1230. As an example, the receiver can be similar to receiver 222 in FIG. 2.

A subsequent activity in method 1500 is an activity 1568 of providing or stopping to provide electrical power to the first electrical device based on the second wireless signal. In one example, the second wireless signal is translated to an intermediary signal (i.e., an electrical signal inside the electrical power device) and transmitted from receiver 222 (FIG. 1) to switch 221 (FIG. 1). Switch 221 (FIG. 2) uses the intermediary signal, which contains the user instruction from activity 1562, to turn on or turn off at least one of electrical outlets 131, 132, 133, and 134 (FIG. 1). That is, switch 221 (FIG. 1) can start or stop the providing of electrical power to one or more electrical devices coupled to electrical outlets 131, 132, 133, and 134 (FIG. 1).

Activity 1562 through activity 1568 of method 1500 can be repeated to change the power setting of electrical outlets based on user instructions entered into the control device.

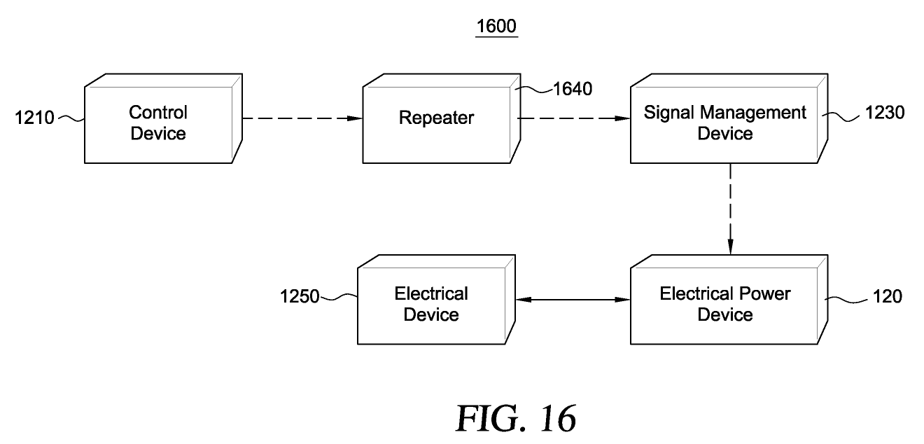

Turning to another embodiment, FIG. 16 illustrates a system 1600 for providing electrical power to electrical device 1250, according to an eleventh embodiment. In this embodiment, an apparatus or system 1600 that provides electrical power to electrical device 1250 can include: (a) control device 1210; (b) a repeater 1640; (c) signal management device 1230; and (d) electrical power device 120. Using repeater 1640 allows a user to control electrical power device 120 from a distance further than would be possible otherwise.

In some examples of system 1600, control device 1210 can receive instructions from a user and wirelessly transmit the user instructions to repeater 1640 over a first medium. Repeater 1640 can retransmit or relay the user instruction to signal management device 1230 over the first medium or a second medium. Signal management device 1230 can receive the user instructions and wirelessly transmit or further relay the user instruction to electrical power device 120 using the first or second medium or a third medium. Finally, electrical power device 120 can use the user instructions to turn on or off the electrical outlet coupled to electrical device 1250.

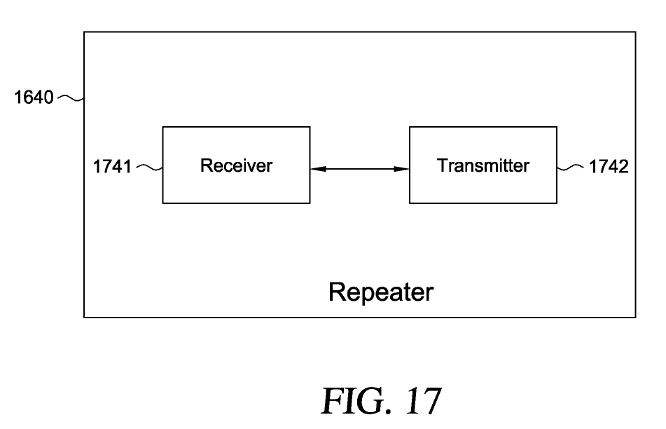

FIG. 17 is a block diagram illustrating repeater 1640, according to the eleventh embodiment. In the embodiment illustrated in FIG. 17, repeater 1640 can include: (a) receiver 1741; and (b) a transmitter 1742 electrically coupled to receiver 1741. In some embodiments, receiver 1741 receives a wireless signal from control device 1210 (FIG. 16) and translates the wireless signal into an intermediary signal (i.e., an electrical signal in repeater 1640). Receiver 1741 then communicates the intermediary signal to transmitter 1742. Transmitter 1742 translates the intermediary signal into a wireless signal and transmits the wireless signal to receiver 1421 (FIG. 14) of signal management device 1230 (FIG. 14) using the first or second medium. In one embodiment, transmitter 1742 transmits the same wireless signal that receiver 1741 received.

Although the invention has been described with reference to specific embodiments, it will be understood by those skilled in the art that various changes may be made without departing from the spirit or scope of the invention. For example, the power strip can have different number of electrical outlets. That is, the power strip could have two electrical outlets, three electrical outlets, four electrical outlets, five electrical outlets, etc. Furthermore, the electrical outlets can be two receptacle outlets (i.e., no ground receptacle) instead of the three receptacle outlets. In yet another example, signal management device 1230 can include a second transmitter and/or second receiver. The second transmitter and/or second receiver would allow signal management device 1230 to receive and/or transmit on two frequencies and/or using two different mediums (e.g., RF signals and infrared signals). Likewise, control device 110 can have two transmitters and electrical power device 120 can have two receivers. Additional examples of such changes have been given in the foregoing description. Accordingly, the disclosure of embodiments of the invention is intended to be illustrative of the scope of the invention and is not intended to be limiting.

It is intended that the scope of the invention shall be limited only to the extent required by the appended claims. To one of ordinary skill in the art, it will be readily apparent that the power strip, apparatus, device, system, and method of use discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required. or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A surge protector comprising:
an electrical connector configured to receive electrical power;
one or more receivers configured to receive input via wireless signals;
at least one first switch electrically coupled to the electrical connector;
one or more first electrical outlets; and
one or more second electrical outlets electrically coupled to the electrical connector,
wherein:
each switch of the at least one first switch is electrically coupled to at least one of the one or more first electrical outlets and at least one of the one or more receivers;
the at least one first switch is configured to turn on or turn off the electrical power to the one or more first electrical outlets based on the input received by the one or more receivers; and
the one or more second electrical outlets are coupled to the electrical connector such that when the electrical connector receives electrical power, the one or more second electrical outlets receive electrical power.

2. The surge protector of claim 1, wherein:
the at least one first switch is configured to turn on or turn off the electrical power individually to each of the one or more first electrical outlets based on input received by the one or more receivers.

3. The surge protector of claim 1, further comprising:
a power toggle mechanism configured to allow a user to turn on or turn off the electrical power to the one or more first electrical outlets.

4. The surge protector of claim 3, wherein:
the power toggle mechanism is further configured to allow a user to turn on or turn off the electrical power to the one or more second electrical outlets.

5. The surge protector of claim 1, further comprising:
at least one second switch electrically coupled to the at least one first switch such that a first switch of the at least one second switch is configured to allow a user to choose whether a first outlet of the one or more first electrical outlets is on, off, or controlled by a remote control.

6. An apparatus for providing electrical power to a first electrical device, the apparatus comprising:
an electrical power device comprising:
a switch;
at least two first electrical connectors electrically coupled to the switch;
at least one second electrical connector; and
a receiver electrically coupled to the switch and configured to wirelessly receive information; and
a control device comprising:
a transmitter configured to wirelessly transmit the information to the receiver of the electrical power device; and
a user input mechanism electrically coupled to the transmitter and configured to receive the information from a user,
wherein:
the switch is configured to toggle electrical power to the at least two first electrical connectors based on the information received by the receiver; and
the at least one second electrical connector receives electrical power when the electrical power device is receiving electrical power regardless of the information received by the receiver.

7. The system of claim 6, wherein:
the transmitter of the control device is configured to transmit the information over a first medium; and
the receiver of the electrical power device is configured to receive the information over the first medium; and
the first medium is a radio frequency.

8. The apparatus of claim 6, wherein
the switch is configured to individually toggle electrical power to each of the at least two first electrical connectors based on the information received by the receiver.

9. The apparatus of claim 6, wherein:
the electrical power device further comprises:
a power toggle mechanism coupled to the at least two first electrical connectors such that the user can toggle the electrical power to the at least two first electrical connectors using the power toggle mechanism.

10. The apparatus of claim 7, wherein:
the electrical power device further comprises:
an electrical plug;
each of the at least two first electrical connectors comprises:
a hot prong;
a neutral prong; and
a ground prong;
one of the hot prong and the neutral prong of each of the at least two first electrical connectors is electrically coupled to the switch; and
ground prong is electrically coupled to the electrical plug.

11. A system for providing electrical power to at least one first electrical device, the system comprising:
an electrical power device comprising:
at least one first electrical connector configured to electrically couple to the at least one first electrical device;
a first receiver configured to receive a first wireless signal over a first medium; and
a switch electrically coupled to the first receiver and the at least one first electrical connector, the switch configured to control providing of electrical power to the at least one first electrical connector based on the first wireless signal; and
a signal management device comprising:
a second receiver configured to receive a second wireless signal over a second medium; and
a first transmitter electrically coupled to the second receiver and configured to transmit the first wireless signal over the first medium.

12. The system of claim 11, wherein:
the electrical power device comprises at least one of a surge protector, a power strip, and a power line conditioner.

13. The system of claim 11, further comprising:
a control device comprising:
a first user input mechanism configured to receive instructions from a user;
a second transmitter electrically coupled to the first user input mechanism and configured to translate the instructions received by the first user input mechanism into the second wireless signal and transmit the second wireless signal over the second medium.

14. The system of claim 13, wherein:
the first wireless signal and the second wireless signal comprise the instructions from the user received by the first user input mechanism of the control device.

15. The system of claim 11, wherein:
the first medium is radio frequency.

16. The system of claim 15, wherein:
the second medium is infrared.

17. The system of claim 11, wherein:
the signal management device further comprises:
a user input mechanism electrically coupled to the first transmitter and configured to receive instructions from a user; and
the first transmitter is further configured to translate the instructions from the user into the first wireless signal.

18. The system of claim 11, further comprising:
a repeater comprising:
a third receiver configured to receive the second wireless signal over the second medium;
a third transmitter electrically coupled to the third receiver and configured to transmit the second wireless signal over the second medium.

19. A method of providing electrical power to a first electrical device and a second electrical device, the method comprising:
electrically coupling a first electrical outlet of an electrical power device to an electrical connector of the first electrical device;
electrically coupling a second electrical outlet of the electrical power device to an electrical connector of the second electrical device;
receiving a first input from a user;
transmitting a first signal over a first wireless medium, the first signal comprises the first input;
receiving the first signal;
providing or stopping to provide electrical power to the first electrical connector of the first electrical device based on the first signal; and
providing electrical power to the second electrical connector of the second electrical device regardless of the first signal.

20. The method of claim 19, wherein:
providing or stopping to provide electrical power comprises:
converting the first signal into a second signal, the second signal comprises the first input;
transmitting the second signal over a second wireless medium; and
providing or stopping to provide electrical power to the electrical connector of the second electrical device based on the second signal.

21. The method of claim 19, further comprising:
receiving a second input from the user;
transmitting a second signal over the first wireless medium, the second signal comprises the second input;
receiving the second signal;
providing or stopping to provide electrical power to the electrical connector of the first electrical device based on the second signal.

22. The method of claim 19, wherein:
receiving the first input comprises:
receiving the first input from the user using a remote control;
transmitting the first signal comprises:
transmitting the first signal over the first wireless medium using the remote control; and
receiving the first signal comprises:
receiving the first signal using the electrical power device.
